(19) United States
(12) Patent Application Publication
(10) Pub. No.: US 2008/0088748 A1
(43) Pub. Date: Apr. 17, 2008

(54) Voice multi-function remote control

(76) Inventor: Boon Chen Lim, Quarry Bay (HK)

Correspondence Address: JACOBSON HOLMAN PLLC, 400 SEVENTH STREET N.W., SUITE 600, WASHINGTON, DC, 20004, US

(21) Appl. No.: 11/545,768

(22) Filed: Oct. 11, 2006

(51) Int. Cl. H04N 7/16; H04N 5/44

(52) U.S. Cl. 348/734; 725/29; 725/153; 725/152

(57) ABSTRACT

A remote control apparatus, besides the controlling system for controlling electronics devices such as a television, further includes a timing and alarm system, a display screen, and a recording system with which important data such as important TV programs or favorite channels can be recorded, and each record can be attached with an alarm time. Furthermore, when an alarm time is reached, not only can an alarm be sounded, or an audible announcement be heard, the apparatus can further transmit a control signal to switch the controlled device to the preset important or favorite channel. In addition, a microphone for detecting a response feed back signal from the controlled device, and a processor for processing by the remote control apparatus for responding to the feed back signal are also provided. The display screen can not only display important control data and information, it can also guide and prompt the user to use its important features, and an make important operation, such as a just one key press to access a favorite channel. A speech synthesizer, or voice recording and playing chip can also be used for an operation prompt and important program announcement, when a preset time is reached. In addition, a child-lock feature can also be implemented when the preset time is reached. A method for quick intelligent catching/recording of broadcasting program schedule promo is also included.

### BACKGROUND OF THE INVENTION

There are a lot of remote control apparatus, low end and high end models, in the present market. However, many high end models are complicated to set up and operate. Users find them hard to set up and their operation complicated, even after tedious reading of operation menu.

Furthermore, users welcome apparatus which can help them to conveniently enjoy a favorite program on schedule.

The present invention is going to develop a high end remote control apparatus with said user satisfaction features and yet convenient to use, and easy to set up and operate.

### SUMMARY OF THE INVENTION

A sophisticated display on the face plate of the apparatus is provided. After battery is installed and upon power up, the display will prompt the user how to set up step by step, e.g., the first step is to prompt the user to select the first device to set up.

After completion of the set up, the display screen will further prompt the user to set an alarm time when the time of the program is reached, and further prompt the user to program favorite channel with one key press to select or access the said channel, or further automatically transmit a command switching to the desired channel.

### BRIEF DESCRIPTION OF THE DRAWINGS

The following drawings illustrate examples of various components of the VOICE MULTI-FUNCTION REMOTE CONTROL disclosed herein, and are for illustrative purposes only. Other embodiments that are substantially similar can use other components that have a different appearance.

FIG. 1 illustrates a general organization of one embodiment of the invention.

FIGS. 2-15C illustrate various prompting screens displayed to the user to initially program the remote control.

FIG. 16 illustrates a time line for implementation of the options of the remote control.

### DETAILED DESCRIPTION OF THE PREFERRED EMBODIMENT

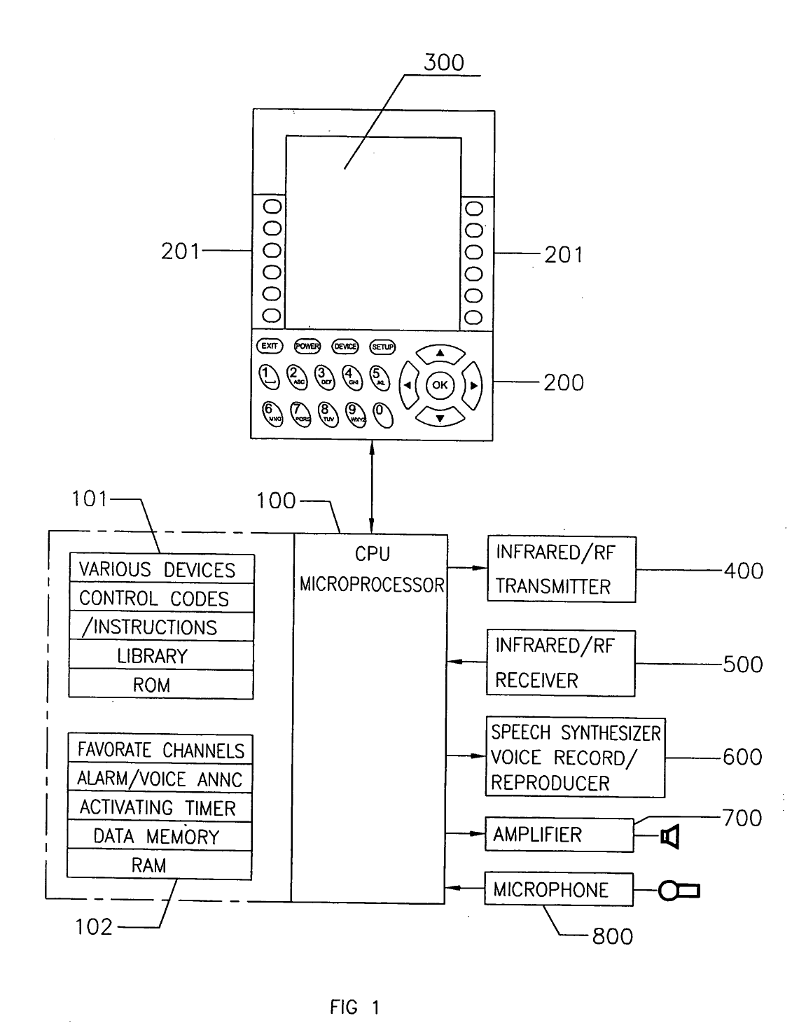

The general organization of one embodiment of the invention is illustrated in the block diagram of FIG. 1, wherein comprising:

Block 100, a Central Processing Unit (CPU) or microprocessor for processing various control function commands with other blocks for the said apparatus.

Block 101, a Read Only Memory (ROM) for pre-programming various operation instruction of the said apparatus, and for pre-programming a library of operation commands or codes of various devices of various categories (TV, DVD, VCR, etc.) and brands.

Block 102, a Random Access Memory (RAM)/Data memory for storing data or favorite or important channels, alarm time and may further be for storing data for activating time of voice announcement.

Block 200 & 201, keyboard for keying in various operation commands.

Block 300, a display for displaying operation command, operation result and operation guide.

Block 400, infrared or Radio Frequency (RF) transmitter for transmitting control command signal to the controlled device, according to the command or instruction instructed by the CPU (Block 100)

Block 500, infrared or Radio Frequency (RF) receiver for receiving learning signal from a learning or other remote control apparatus.

Block 600, Speech synthesizer or Voice recorder and player for making an announcement, or for making recording regarding important program, or making audible guiding of an important operation which is controlled by the CPU.

Block 700, amplifier for increasing the output volume level for the speech synthesizer or voice recorder and player.

Block 800, microphone for detecting the sound from the controlled device.

Upon power up of the above said system of FIG. 1, or when the SET UP key on the keyboard of Block 200 of FIG. 1 is pressed, the CPU of Block 100 is programmed to instruct the display to show a screen to prompt the user to make the set up as shown by FIG. 2.

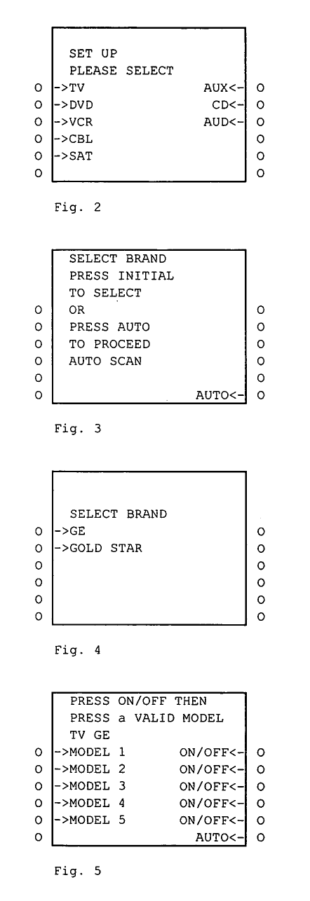

As shown, there are various categories of devices (TV, VCR, DVD, etc.) listed in rows on the left and right side of the display screen. And nearby the name of each device displayed on both sides of each row, there is a corresponding soft key. When the soft key is pressed, the device with the name shown next to the soft key will be selected. This is prompted by the prompt “PLEASE SELECT” displayed on the second row of the display screen. For example, if the corresponding soft key nearby the displayed text “TV” is pressed, then the device of category TV will be selected, and the CPU of block 100 is programmed to cause a second prompt screen to be displayed, as shown in FIG. 3.

Following the prompt of the screen of FIG. 3, the user may select a brand of the device that the user intends to control, by pressing a key on the keyboard 200 which corresponds to the initial character of the name of the brand. A list of the name of the brands with the desired initial character will then be displayed on the screen. For example, the brand “GE” has the initial character “G” in its name. To select this brand, the user may press the key [4 GHI], which correspond to the initial character “G”, on the keyboard 200. The CPU of block 100 will instruct the display 300 to show the next prompting screen, as shown in FIG. 4.

The user may press the soft key nearby the text “GE” displayed in the row to select the brand “GE”. The display 300 will then show a further prompt screen, as shown in FIG. 5. A list of different models of TV produced by the brand “GE” will be displayed.

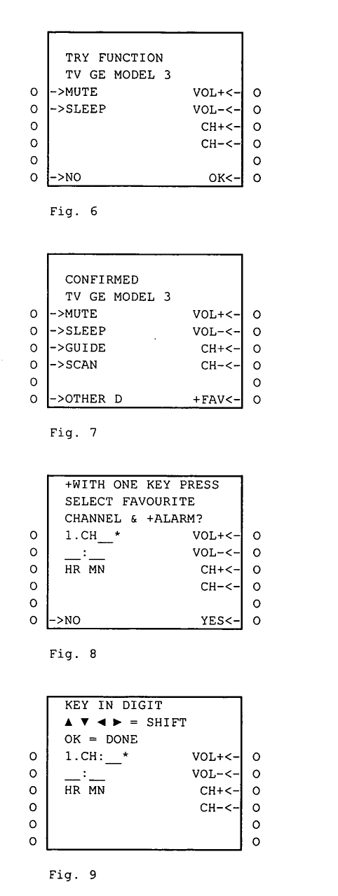

In this screen, the user can test the model of the TV. Following the prompt “PRESS ON/OFF” shown on the first row of the display screen in FIG. 5, the user can press one of the “ON/OFF” soft keys on the same row as the displayed model name. If the “ON/OFF” soft key is valid, the TV being controlled will be powered-on or powered-off when the soft key is pressed. This means the TV being controlled is of the same model, or equivalent to, the model displayed on the same row as the pressed “ON/OFF” soft key. In this case, the user may select the TV model by pressing the soft key next to the model name displayed on the same row as the pressed “ON/OFF” soft key. For example, in FIG. 5, if pressing the “ON/OFF” soft key on the same row as the displayed text “Model 3” can cause the controlled TV to be powered-on or powered-off, the user can then press the soft key next to the displayed text “Model 3” to select this model. A further prompt screen will be displayed, as shown in FIG. 6.

In this screen, the user can try the soft keys displayed on the screen, to see if these soft keys can be used to control the various functions of the TV as advertised. Following the screen prompt “TRY FUNCTON” in FIG. 6, the user may press the “CH+”, “CH−”, “VOL+”, “VOL−” soft keys, etc. If after pressing these soft keys, the channel and volume of the TV has indeed been changed respectively, then the control command of the selected model, in this case “Model 3”, is the correct one for the TV being controlled. The user may then press the “OK” soft key to confirm that the selection of the TV model has been successfully completed. After the “OK” soft key is pressed, a confirmation screen will be displayed, as shown in FIG. 7.

After 3 seconds, a further prompt screen will be displayed, as shown in FIG. 8.

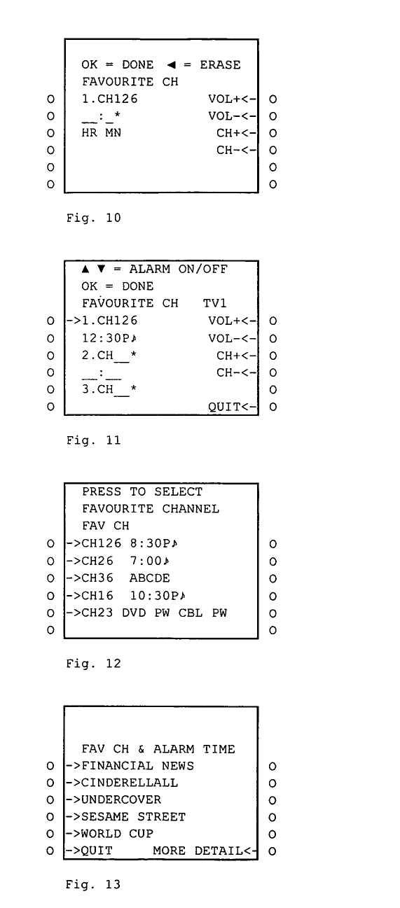

The screen shown in FIG. 8 ask the user if he or she want to set up a just one key access to a favorite channel: “1. CH_*”. If the “YES” soft key is pressed, the display screen is changed to another prompt screen, as shown in FIG. 9.

In FIG. 9, “*” is a flashing cursor, which represents the location for the user to enter a digit. There are more than a hundred (3 digits) channels available through the satellite and cable TV system providers. So, following the screen prompt “KEY IN DIGIT”, a user can program to select a favorite channel, represented by a channel number of up to 3 digits, which can be accessed with only one key press. For example, if the favorite channel is channel 126, then when the screen as shown in FIG. 9 is displayed, the keyboard 200 can be used to key in the digits 1, 2, and 6. After the last digit is entered, the OK (=DONE) key on the keyboard 200 should be pressed, then the set up for one key access for switching to channel 126 is completed. A further prompt screen of FIG. 10 will be displayed.

The screen shown in FIG. 10 hints the user to set an alarm time, hour and minute. The user can input the hour and minute using the keyboard 200, and then press the OK (=DONE) key. For example, the user may key in 12:30P. Then a further prompt screen appears, as shown in FIG. 11.

In FIG. 11, the prompt “▴ ▾=ALARM ON/OFF” hints to the user that the alarm can be enabled or disabled by pressing the up arrow key and down arrow key respectively on the keyboard 200. The [symbol] symbol represents that the alarm has been enabled. There are further hints available. Another two favorite channel, No. 2 and No. 3, can be set up. No. 2 can also be attached with an alarm time, but favorite channel No. 3 can only be used for one key access.

When an alarm time is reached, and if the alarm is enabled, that is, the “ ” symbol is displayed, an alarm sound will be generated, and amplified by amplifier 700. The present remote control apparatus will also try to send a command to the TV, to power on the TV and switch the channel to the favorite channel. However, if a short period of time before the alarm is sounded, a certain level of sound volume is picked up and detected by the microphone 800 and accumulated by the CPU 100, that means that the TV is already powered-on. So, when the alarm time is reached, only a command of switching to the favorite channel, in this example channel 126, will be transmitted from the remote control apparatus to the TV. On the other hand, if a certain level of sound volume is not detected and accumulated a short period of time before the alarm time is reached, before transmitting to the TV the channel switching command, the power on/off command will first be transmitted to the TV, to power-on the television set.

Referring again to the screen shown in FIG. 11, the left side of the screen shows 3 FAV CH (favorite channel), where each of these channels can be selected or accessed by one press of each of the soft keys on the left side respectively. And, on the right side of the screen, there are 4 basic and important prompt and soft keys: CH+, CH−, VOL+, VOL−. These are the frequently used keys, which are almost the only keys found on the front face panel of most TV sets. This arrangement of displaying several favorite channels on the screen, and soft keys for selecting each favorite channel with only one key press, and in the same screen displaying several frequently used function prompts and their corresponding soft keys, will bring highly increased level of convenience of operation to the user.

FIG. 12 shows a further development of a screen displayed by the present remote control apparatus, for expanding the number of favorite channels shown in one screen. As shown, only the prompt of favorite channel and its description, or option of alarm time are being displayed. There is no other function key prompt on the screen. Furthermore, not only a plurality of commands of a single device can be programmed for access by one key press, command of a plurality of devices can also be programmed for sequence access by one key press. For example, the prompt on second last row in FIG. 12 is “CH23 DVD PW CBL PW”. This means, with one key press of the corresponding soft key on this row, commands will be transmitted to switch the TV to channel 23, and the power of the DVD and CBL will also be switched on.

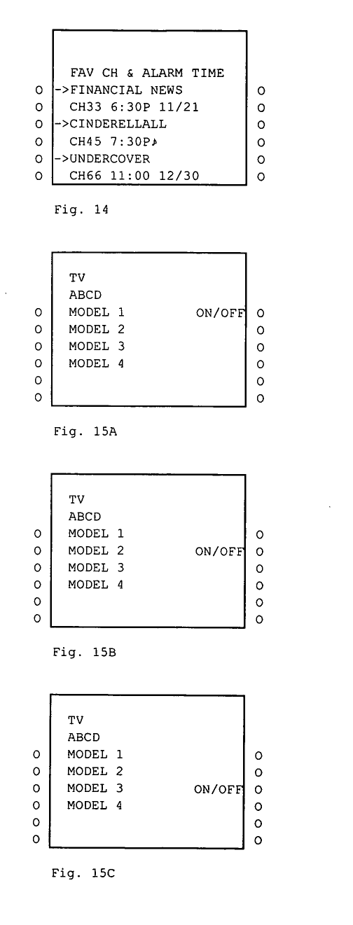

FIG. 13 shows another further development of a screen displayed by the present remote control apparatus, where one key press access of favorite channels, alarm and auto switching time can be displayed. As shown on the screen, name and brief description of the program broadcasted to the TV on the selected time can also be inputted using the keyboard 200. If the user press the “MORE DETAIL” soft key, a further screen as shown in FIG. 14 is displayed, showing the channel number, date and time, and program name for the favorite channel and associated alarm time.

The present invention further develops an auto scan set up method. Referring back to FIG. 3, there is a soft key called “AUTO” which is located at the bottom right of the display. On the screen, there is also a prompt “PRESS AUTO TO PROCEED AUTO SCAN”. Following this prompt, if the user presses the “AUTO” soft key, the present remote control apparatus will transmit the power on/off command of different television brands and models to the TV in sequence. These power on/off commands are pre-programmed in the library of ROM 101. The screen as shown in FIGS. 15A, B and C will be displayed.

As shown in FIG. 15A, an “ON/OFF” label is displayed on the right side of the label “MODEL 1”. As mentioned above, at the same time, the power on/off signal for TV model 1 will be transmitted to the TV. After 2 seconds, the screen in FIG. 15B will be displayed. The “ON/OFF” label has been moved to the right side of the label “MODEL 2”. At the same time, the power on/off signal for TV model 2 will be transmitted to the TV. After another 2 seconds, the screen in FIG. 15C will be displayed. The “ON/OFF” label is moved to the right side of the label “MODEL 3”, while the power on/off signal for TV model 3 will also be transmitted to the TV. The present remote control apparatus will continue to move the “ON/OFF” label to the right side of label different TV model, and also transmit the power on/off signal for the said TV model, by going through a list of TV model names and their corresponding power on/off signal stored in the ROM 101.

After the power on/off signal was transmitted, the microphone 800 will try to detect, whether there is a sound or not. If a sound can be detected, this means that the TV has been successfully switched on by the power on/off command transmitted by the present remote control apparatus, and the sound of a TV program is played by the TV. Hence, if a certain volume level of sound is detected and accumulated by CPU 100, the CPU will consider the last transmitted power on/off signal for the current model as valid, and stop the transmission of the power on/off signal for the subsequent models. An indication is then shown on the display screen 300, or a sound or voice announcement can be generated to inform the user that a correct model for the TV has been selected. It is possible to proceed to further automatically test the other command signal, such as mute, volume up and volume down. The command signal for these operations for the selected TV model can be transmitted to the TV, which should cause a corresponding change in the sound volume level played by the TV, which can in turn be detected by the microphone 800.

The time interval between the transmission of different power on/off signals for different TV models can be varied. A longer time interval will increase the reliability of the testing result, but it will take a longer time to complete the testing for all the available TV models. On the contrary, a shorter time interval will decrease the reliability of the test results.

To increase the reliability of the test results, the present invention can further develop a repeat testing procedure. Once a power on/off signal of a certain TV model is detected as valid, the transmission of the power on/off signal for the next TV models is stopped immediately. Instead, the power on/off signal of the selected TV model is repeatedly transmitted for a certain number of times. If the power on/off signal is indeed correct for the receiving TV, transmitting the power on/off signal for a second time should cause the TV to be switched off. The sound played by the TV should then be stopped, so the microphone 800 should be able to detect a significant decrease of sound volume level or silence. If the power on/off signal is transmitted for a third time, the TV should be switched on again. Sound is thus played by the TV again, so the microphone 800 should be able to detect a significant increase of volume level of sound. Hence, the validity of the test is made more reliable.

When switching on most kinds of sound generating devices, there is likely to be some delay before the sound is generated. On the other hand, when the sound generating device is switched off, it is likely that the sound will be stopped very quickly. So, by transmitting a power off command for the above testing, the time required for the testing can be decreased. And, at the same time, using the repeat testing method described above, the decrease in reliability can be compensated.

As mentioned previously, voice recorder and player are provided in this remote control apparatus of the present invention. It can also be used for recording and announcing of important TV program promo and voice assisted operation instruction. The present invention further develops an intelligent method (named as Program Super Catcher) for catching and voice recording of important program promo. Usually, in television broadcast, the duration of broadcast of promo of TV program is very short and quick, usually about 30 seconds or less. When a user is listening to a TV program promo, it will take some time for the user to consider it worthwhile to make a voice recording of the TV program promo or not. If the user then decides that the TV program promo is useful and presses a key to start a voice recording, it may already too late. The beginning part of the TV program promo has already been elapsed, so only the remaining part can be recorded. This means essential information from the TV program promo cannot be recorded. The method of the said Program Super Catcher of the present invention can solve such a problem as below. The recording system of the present apparatus is designed to be pre-activated to start a voice recording any time, well before the start of the broadcasting of TV program promo. After the pre-activation, the present apparatus will make voice recording all the time. However, obviously the size of the memory for storing the voice recording cannot be unlimited. So, only a pre-determined length of voice, say 20 seconds of the latest recorded data, can be kept in the record data memory. The oldest voice data are automatically discarded when new voice data are recorded. So when a user listens to the TV program promo, and when the user decides to make a recording by activating a subsequence starting means to start a voice recording, a pre-determined length of the latest voice recording (in this example, 20 seconds) is already stored in the present invention's memory. Another pre-determined length of voice is further recorded after the activation of the starting means, for example, 15 seconds. By combining the voice recording made before the user activates the starting means, and those after the user activates the starting means, a voice recording of the entire TV program promo can be obtained (in this example, the total length of the voice recording is 20+15=35 seconds). Thus, important content of the TV program promo will not be missing from the voice recording, even if there is a time delay between the start of the TV program promo and the action of the user to activate the voice recording after the user considers it worthwhile to record the TV program promo. At the same time, it is apparently, by using this novel method, the memory capacity for the voice recording system can thus be well organized and economized. The length of voice recording after the user activates the second starting means can also be controlled by the user by activating a stop means.

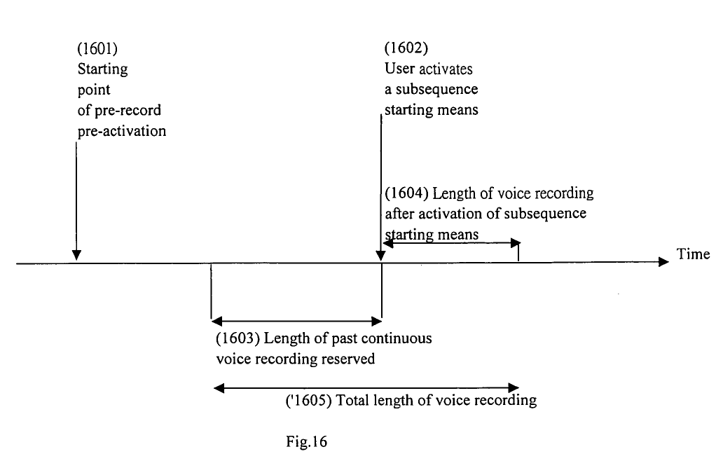

FIG. 16 helps to illustrate this aspect of the present invention. At point 1601, the user pre-activates the system for pre-recording. The apparatus then continue to record voice all the time. As the area of memory allocated for storing voice recording data become full, the oldest voice data are discarded to make room for storing the newer voice data. When the user hears a TV program promo that the user want to record, the user activates a subsequence starting means, as represented by point 1602. A pre-determined length of voice recording made before the activation of the subsequence starting means is then reserved and kept, as represented by 1603. The apparatus will continue to record voice for another pre-determined length of time after the activation of the subsequence starting means, as represented by 1604. The length of the complete voice recording obtained by combining the voice recording segments before and after the activation of the subsequence starting means is marked by the time interval 1605.

Apparently, in addition to a remote control apparatus, the above mentioned method of Program Super Catcher can also be used in any recorder. And the above mentioned method can be used not only in a audio recorder, but can also be used in a video recorder.

Furthermore, for economic organizing of memory capacity, the said method of Program Super Catcher can also be used in editing of voice recording. During a recording playback, when the voice playback reaches a certain point determined by the user, the user can activate a cut means. The portion of the voice recording which has already been played before the cut means is activated will be kept by the system, and the portion of voice recording not yet played will be discarded by the system. In this way, the length of the voice recording can be reduced, and thus the memory used by the voice recording can be decreased, freeing up more memory for making other voice recordings.

It is also noteworthy that some families would like to have a child lock-out feature for their home appliances, for example, a TV, during certain hours. The auto-transmission of remote control command during a pre-defined time of the present invention can be extended to lock the home appliance. For example, for a TV, the present invention can be programmed to transmit a channel switching command every regular time interval continuously to switch to a null or blank program channel. The said auto-transmission of control command can also be a volume-down command, a mute command, or a combination of multiple commands, etc. As a result, a child cannot access the TV channels during the per-defined time inputted into the present invention.

Of course, in such a case, the remote control apparatus should only be put in a special place which is not easily accessible by the child. Furthermore, for a remote control using infrared command signal, the remote control must be constantly in a direction pointing toward the home appliance in order for the command signal to be received. But if the remote control apparatus uses Radio Frequency which is non-directional for sending a command signal, the command can be received regardless of the orientation of the remote control apparatus, then it is easier to accomplish this child-lock function.

1. A remote control apparatus comprising:
an infrared or Radio Frequency remote control system, for transmitting remote controlling instruction to control various electronics device or appliance;
a display screen for displaying remote control instruction, user operation guide, alarm time and control instruction activating time;
a data memory for storing controlling and displaying data.

2. A remote control apparatus of claim 1, wherein further comprise a detecting means for detecting whether or not, in respond to the said control instruction signal, a feed back sound or light signal is detected or received, and depending on the result of detection, determine what following subsequent instruction have to process.

3. A remote control apparatus of claim 2, wherein the said subsequent instruction is to determine, whether or not to transmit a power on/off instruction.

4. A remote control apparatus of claim 3, where in prior to the said sound or light signal detection, a power on/off instruction was transmitted, and in respond to the said transmitted instruction, if a valid sound or light signal is not detected, the subsequent instruction is to transmit the next model's power on/off instruction, from a list of power on/off instruction of different models. And if a valid feed back signal is detected, the subsequent instruction is to test or emit the instruction of other functions for this said model, or to generate a sound or speech, or to display a success message on the screen, to indicate the successful selection of model. And then the testing process is stopped, and the apparatus wait for user's action.

5. An apparatus of claim 4, wherein the display format is a list of favorite channel and alarm time or text, or both alarm and text can be attached.

6. An apparatus of claim 5, wherein the display format show only few favorite channels and said attachment of alarm or text, but besides, some important prompts or labels of function key are also shown on display, for convenient of function operation.

7. An apparatus of claim 5, wherein the display format further includes displaying the description of the program of the channel, and the time of the program.

8. An apparatus of claim 6, wherein besides to each description or record of each said favorite channel on the display, there is a corresponding soft key, which can be just pressed once to activate the channel switching function as prompted by the description.

9. An apparatus of claim 8, wherein visual display means or audible voice means, or both, are provided for operation guide, and audible means are further provided for important programs or other important event recording and announcement, when a preset alarm time is reached, or when an activation means is activated by the user.

10. An apparatus of claim 1, wherein the audible voice recording system further comprising
a pre-record system which can be pre-activated by a pre-activating means to make voice recording all the time,
a data memory with a pre-determined size reserved for storing a pre-determined length of voice recording, automatically discarding oldest voice data when new voice data is stored when the pre-determined size storage become full,
a subsequent activating means for reserving for later processing the latest voice recording made by the said pre-recorded system and stored in the said data memory when the said activating means is activated

11. An apparatus of claim 10, wherein after the activation of the said subsequence activation means, the system will continue the voice recording for another pre-determined length of time, and combine the said recording with the voice recording made before the activation of the subsequence activation means reserved in the said data memory.

12. An apparatus of claim 1, which including a video recording system further comprising
a pre-record system which can be pre-activated by a pre-activating means to make video recording all the time,
a data memory with a pre-determined size reserved for storing a pre-determined length of video recording, automatically discarding oldest video data when new video data is stored when the pre-determined size storage become full,
a subsequent activating means for reserving for later processing the latest video recording made by the said pre-recorded system and stored in the said data memory when the said activating means is activated

13. An apparatus of claim 12, wherein after the activation of the said subsequence activation means, the system will continue the video recording for another pre-determined length of time, and combine the said recording with the video recording made before the activation of the subsequence activation means reserved in the said data memory.

14. An apparatus with a audible voice recording system comprising
a pre-record system which can be pre-activated by a pre-activating means to make voice recording all the time,
a data memory with a pre-determined size reserved for storing a pre-determined length of voice recording, automatically discarding oldest voice data when new voice data is stored when the pre-determined size storage become full,
a subsequent activating means for reserving for later processing the latest voice recording made by the said pre-recorded system and stored in the said data memory when the said activating means is activated

15. An apparatus of claim 14, wherein after the activation of the said subsequence activation means, the system will continue the voice recording for another pre-determined length of time, and combine the said recording with the voice recording made before the activation of the subsequence activation means reserved in the said data memory.

16. An apparatus with a video recording system comprising
a pre-record system which can be pre-activated by a pre-activating means to make video recording all the time,
a data memory with a pre-determined size reserved for storing a pre-determined length of video recording, automatically discarding oldest video data when new video data is stored when the pre-determined size storage become full,
a subsequent activating means for reserving for later processing the latest video recording made by the said pre-recorded system and stored in the said data memory when the said activating means is activated

17. An apparatus of claim 16, wherein after the activation of the said subsequence activation means, the system will continue the video recording for another pre-determined length of time, and combine the said recording with the video recording made before the activation of the subsequence activation means reserved in the said data memory.

18. An apparatus of claim 1, further comprising:
a time inputting means for inputting a user selected time;
a clock means for keeping the current date and time;
a timer means for determining if the time inputted in the said time inputting means has been reached;
a block commands signal sending means, for sending command signals to a home appliance to block the use of the said home appliance, when the said timer means has determined that the time inputted in the said time inputting means has been reached.

19. An apparatus of claim 18, wherein the said block command is a channel switching command to switch the home appliance to a empty or blank channel, and the said block command is repeatedly sent at a regular time interval.

20. An apparatus of claim 18, wherein the said block commands are a combination of one or multiple commands for switching channel, volume down, mute or other commands.
